(19) United States
(12) Patent Application Publication
(10) Pub. No.: US 2012/0133090 A1
(43) Pub. Date: May 31, 2012

(54) Supplementary vehicle spring assembly

(75) Inventor: William Wlfred Spencer, East London (ZA)

(73) Assignee: Roadmaster Active Suspension, Inc., Charlotte, NC (US)

(21) Appl. No.: 13/317,689

(22) Filed: Oct. 19, 2011

(30) Foreign Application Priority Data
Apr. 14, 2009 (IB) PCT/IB2010/051601
Apr. 14, 2009 (ZA) 2009/02529
Dec. 23, 2009 (ZA) 2009/09206

(51) Int. Cl. B60G 11/36

(52) U.S. Cl. 267/289

(57) ABSTRACT

A supplementary vehicle spring assembly for a leaf spring of a vehicle is provided, the leaf spring defining a fixed end and a free end. The supplementary vehicle spring assembly comprises a first tension spring arrangement fitted to the fixed end of the leaf spring, a second tension spring arrangement fitted to the free end of the leaf spring, and a bracket arrangement proximate an axle of the vehicle, the bracket arrangement connecting the first and second tension spring arrangements. The first and second tension spring arrangements each comprise a connector arm for securing the arrangements to the respective ends of the leaf spring, a first connector rod extending from the connector arm and being secured to a first end of at least one tension spring, and a second connector rod extending from a second end of the tension spring, the second connector rods securing the first and second tension spring arrangements to opposite ends of the bracket arrangement.

### BACKGROUND OF THE INVENTION

This invention relates to a supplementary vehicle spring assembly for supplementing the compressive resistance of a vehicle leaf spring, the leaf spring defining a free end and fixed end.

Supplementary vehicle spring assemblies are well known and may take any one of a number of various configurations. In particular, many mobile workshop vehicles are fitted with supplementary vehicle spring assemblies. However, as a result of excessive loading and poor road conditions, the vehicle's leaf springs and axle experience numerous jarring, sharp and irregular forces. The resultant extreme deflections experienced by the leaf springs place high stresses on the ends of the leaf spring, with the fixed end eye of the leaf spring, in particular, tending to break relatively regularly.

It is therefore an aim of the present invention to provide a supplementary vehicle spring assembly that is easy to install, and that can react quickly depending upon the terrain that vehicle is traversing.

### SUMMARY OF THE INVENTION

According to the invention there is provided a supplementary vehicle spring assembly for a leaf spring of a vehicle, the leaf spring defining a fixed end and a free end, the supplementary vehicle spring assembly comprising:
a first tension spring arrangement fitted to the fixed end of the leaf spring;
a second tension spring arrangement fitted to the free end of the leaf spring; and
a bracket arrangement proximate an axle of the vehicle, the bracket arrangement connecting the first and second tension spring arrangements.

The first and second tension spring arrangements each comprise a connector arm for securing the arrangements to the respective ends of the leaf spring, a first connector rod extending from the connector arm and being secured to a first end of at least one tension spring, and a second connector rod extending from a second end of the tension spring, the second connector rods securing the first and second tension spring arrangements to opposite ends of the bracket arrangement.

In an embodiment, the second tension spring arrangement proximate the free end comprises a pair of springs.

In an embodiment, an adjustment arrangement is provided between the first ends of the pair of springs and the first connector rod.

In an example embodiment, the bracket arrangement comprises a first pair of spaced apart arms and a cross-member to which the second connector rod of the first tension spring arrangement is secured, the first pair of spaced apart arms and cross-member defining a moving shackle.

In one version, the second connector rod of the first tension spring arrangement extending from the second end of the tension spring comprises a spherical bearing that in turn is fitted to the cross-member.

In an alternate version, the cross-member is rotatably fitted between the first pair of spaced apart arms, with the second connector rod of the first tension spring arrangement being secured to the rotatable cross-member.

In an example embodiment, the bracket arrangement further comprises a second pair of spaced apart arms and a cross-member to which the second connector rod of the second tension spring arrangement is secured.

In one version, the second connector rod extending from the second end of each tension spring of the second tension spring arrangement comprises a spherical bearing that in turn is fitted to the cross-member.

In an alternate version, the cross-member is rotatably fitted between the second pair of spaced apart arms, with the second connector rod of the second tension spring arrangement being secured to the rotatable cross-member.

In an example embodiment, the first and second pairs of spaced apart arms, opposite their respective cross-members, are rotatably connected together so as to define the bracket arrangement.

In an example embodiment, the cross-members of the first and second pairs of spaced apart arms are located above the leaf spring, with the rotatable connection of the first and second pairs of spaced apart arms being located below the leaf spring.

In an example embodiment, the connector arms of the first and second tension spring arrangements terminate in curved ends for accommodating, from above, the scrolled ends of the leaf spring.

In an alternate example embodiment, the connector arms of the first and/or second tension spring arrangements terminate in a connector fitting that encloses the scrolled ends of the leaf spring.

According to a further aspect of the invention there is provided a tension spring arrangement for a leaf spring of a vehicle, the leaf spring defining a fixed end and a free end, the tension spring arrangement comprising:
a connector arm for securing the arrangement to the fixed end of the leaf spring;
a first connector rod extending from the connector arm and being secured to a first end of at least one tension spring;
a second connector rod extending from a second end of the tension spring; and
a bracket arrangement proximate an axle of the vehicle, the second connector rod terminating in a spherical bearing rotatably fitted to the bracket arrangement to define a spherical bearing connection.

In an embodiment, a pair of springs are provided.

In an embodiment, the bracket arrangement comprises a pair of spaced apart arms and a cross-member that receives the spherical bearing of the second connector rod.

In an embodiment, at least one spacer is fitted to the cross-member, the at least one spacer extending on at least one side of the spherical bearing.

### BRIEF DESCRIPTION OF THE DRAWINGS

FIG. 1 shows a perspective view of a supplementary vehicle spring assembly according to a first example embodiment of the present invention;

FIG. 2 shows a perspective view of a supplementary vehicle spring assembly according to a second example embodiment of the present invention;

FIGS. 3A and 3B show, respectively, a side view and a top view of an alternate connector fitting for securing an end of the supplementary vehicle spring assembly substantially of the type shown in either FIG. 1 or FIG. 2 to a scrolled end of a leaf spring;

FIG. 4 shows a perspective view of a supplementary vehicle spring assembly according to a third example embodiment of the present invention;

FIG. 5 shows a perspective view of a supplementary vehicle spring assembly according to a fourth example embodiment of the present invention; and

FIG. 6 shows a perspective view of a connecting arrangement for fitting an end of a tension spring to an end of a leaf spring assembly, according to a further example embodiment of the present invention.

### DESCRIPTION OF PREFERRED EMBODIMENTS

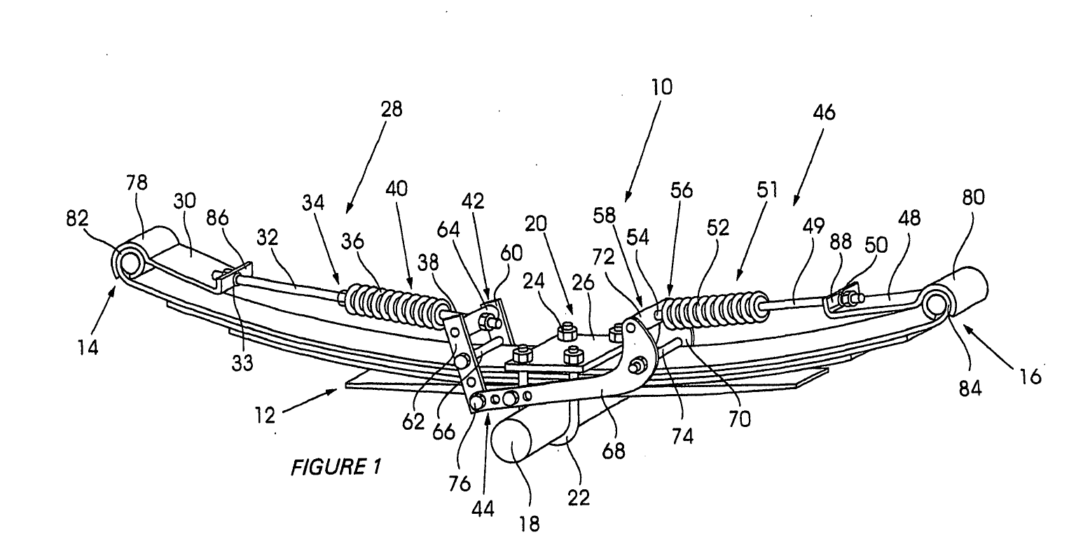

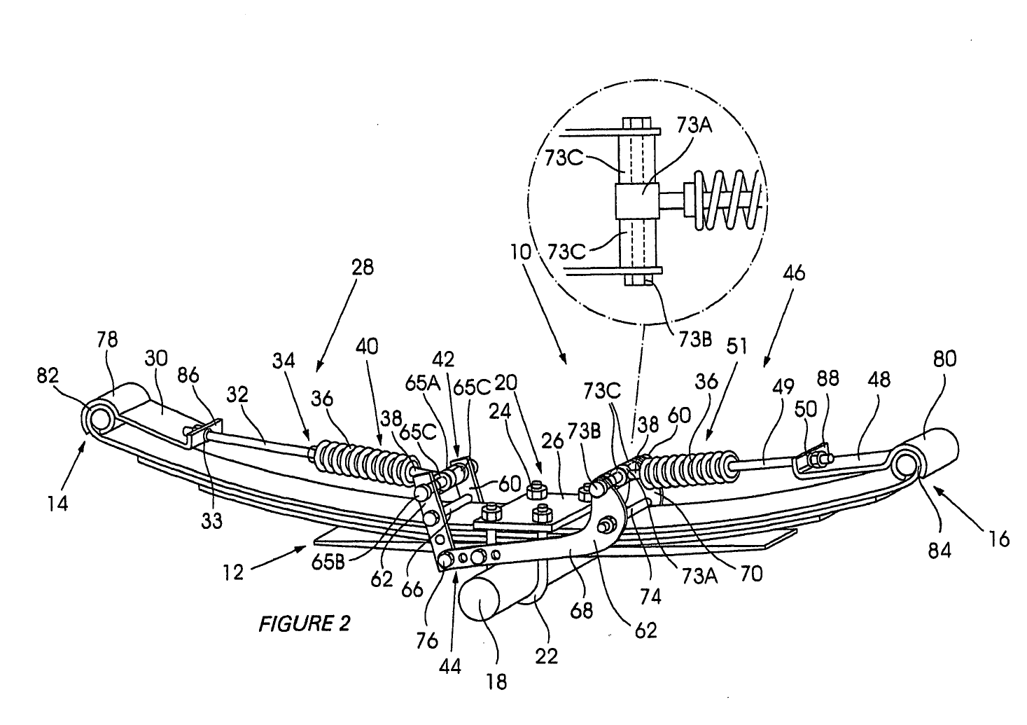

Referring first to FIGS. 1 and 2, which are substantially similar, a supplementary vehicle spring assembly 10 for an axle-mounted leaf spring assembly 12 of a vehicle is shown, the leaf spring assembly 12 defining a front, fixed end 14 and a rear, free end 16 as is well known in the art. The leaf spring assembly 12 is secured to a vehicle axle 18 by a securing arrangement 20. Typically, the securing arrangement 20 comprises a pair of U-bolts 22, 24 that clamp the leaf spring assembly 12 and the axle 18 together using a clamping plate 26. FIG. 1 shows the arrangement in which the axle 18 is mounted below the leaf spring assembly 12, but, advantageously, the supplementary vehicle spring assembly 10 of the present invention may also be used in arrangements in which the axle 18 is mounted above the leaf spring assembly 12.

The supplementary vehicle spring assembly 10 comprises a first tension spring arrangement 28 fitted to the fixed end 14 of the leaf spring 12. The first tension spring arrangement 28 comprises a connector arm 30 for securing the arrangement 28 to the fixed end 14 of the leaf spring 12. A first threaded connector rod 32 extends from the connector arm 30, via a fitted cup bearing 33, and is adjustably securable to a first end 34 of a tension spring 36. A second threaded connector rod 38 extends from a second end 40 of the tension spring 36, the second connector rod 38 securing the first tension spring arrangement 28 to an end 42 of a bracket arrangement 44. The bracket arrangement 44 will be described in more detail further on in the specification.

The supplementary vehicle spring assembly 10 comprises a second tension spring arrangement 46 fitted to the free end 16 of the leaf spring 12. As with the first tension spring arrangement 28, the second tension spring arrangement 46 comprises a connector arm 48 for securing the arrangement 46 to the free end 16 of the leaf spring 12. A first threaded connector rod 49 extends from the connector arm 48, via a fitted cup bearing 50, and is also adjustably securable to a first end 51 of a tension spring 52. A second threaded connector rod 54 extends from a second end 56 of the tension spring 52, the second connector rod 54 securing the second tension spring arrangement 46 to an opposite end 58 of the bracket arrangement 44.

The tension spring 36 of the first tension spring arrangement 28 defines an active tension spring. Depending on the load rate of the leaf spring 12, the tension spring 36 may have a thicker (or the same) gauge than that of the tension spring 52 of the second tension spring arrangement 46. In an embodiment, the tension springs 36, 52 are interchangeable.

The bracket arrangement 44 is positioned proximate an axle 18 of the vehicle, and in particular, proximate the region where the leaf spring assembly 12 is bolted to the axle 18. The bracket arrangement 44 connects the first and second tension spring arrangements 28, 46 together and to the leaf spring assembly 12. In particular, the bracket arrangement 44 is arranged to anchor the first and second tension spring arrangements 28, 46 between the axle 18 and the clamping plate 26, on opposite sides of the U-bolts 22, 24.

In an example embodiment, the bracket arrangement 44 comprises a first pair of spaced apart arms or link plates 60, 62, and a rotatable spacer cross-member 64 that defines an articulated connection. The rotatable spacer cross-member 64 defines a threaded aperture for securingly receiving the threaded end of the second connector rod 38 of the first tension spring arrangement 28. This rotating, articulated arrangement ensures that the axle 18 and the coil springs 36, 52 are always aligned in the direction of the force being applied to it. Accordingly, and because of the instantaneous mechanical reaction of the springs 36, 52, the overall stability of the vehicle is dramatically improved.

Alternatively, as shown in FIG. 2, the connector rod 38 may terminate in a spherical bearing 65A that can receive a cross-member bolt 65B, which in turn is used to secure the spherical bearing 65A to the first pair of spaced apart arms 60, 62. In this alternate version, a pair of solid spacers 65C may be fitted onto the bolt 65B, on either side of the spherical bearing 65A. This alternate configuration significantly increases the strength of the securing arrangement 20 and ensures smooth operation of the assembly 10.

Referring back to FIG. 1, the first pair of spaced apart arms 60, 62 and rotatable cross-member 64 define a moving shackle. One or more additional spacers, such as spacer 66, may extend between the arms 60, 62. The arms 60, 62 are sized to accommodate the leaf spring assembly 12 therebetween.

The bracket arrangement 44 further comprises a second pair of spaced apart L-shaped arms 68, 70 and a rotatable spacer cross-member 72. Again, the cross-member 72 defines an aperture for threadably receiving the threaded end of the second connector rod 54 of the second tension spring arrangement 46. As with the connector rod 38, in the alternative embodiment shown in FIG. 2, the connector rod 54 may terminate in a spherical bearing 73A that can receive a cross-member bolt 73B, which in turn is used to secure the spherical bearing 73A to the second pair of spaced apart arms 68, 70. In this alternate version, a pair of solid spacers 73C may be fitted onto the bolt 73B, on either side of the spherical bearing 73A. Again, one or more additional spacers, such as spacer 74, may extend between the arms 68, 70.

In an example embodiment, the first and second pairs of spaced apart arms, 60 and 62, and 68 and 70, opposite their respective rotatable cross-members, 64 and 72, are rotatably connected together with a bolt 76 so as to overall define the bracket arrangement 44.

As shown in FIGS. 1 and 2, the rotatable cross-members 64, 72 of the first and second pairs of spaced apart arms 60, 62, and 68, 70, respectively, are located above the leaf spring 12, with the rotatable connection, defined by bolt 76, of the first and second pairs of spaced apart arms 60, 62, 68, and 70, being located below the leaf spring assembly 12.

In an example embodiment, the connector arms 30, 48 of the first and second tension spring arrangements 28, 46, respectively, terminate in curved ends 78, 80 for accommodating, from above, the scrolled ends 82, 84 of the ends of the leaf spring 12. The curved ends 78, 80 of the connector arms 30, 48 automatically adjust themselves to any alignment of the tension springs 36, 52, irrespective of the up and down deflection and reflection of the leaf spring assembly 12.

Flanged ends 86, 88 of the connector arms 30, 48, respectively, define threaded apertures for receiving the threaded rods 32, 49 extending from the first ends 34, 51 of the tension springs 36, 52. As indicated above, the flanged ends 86, 88 are fitted with cup bearings 33, 50 that are set into recesses defined in the flanged ends 86, 88. The cup bearings 33, 50 allow movement on the joints defined at these regions.

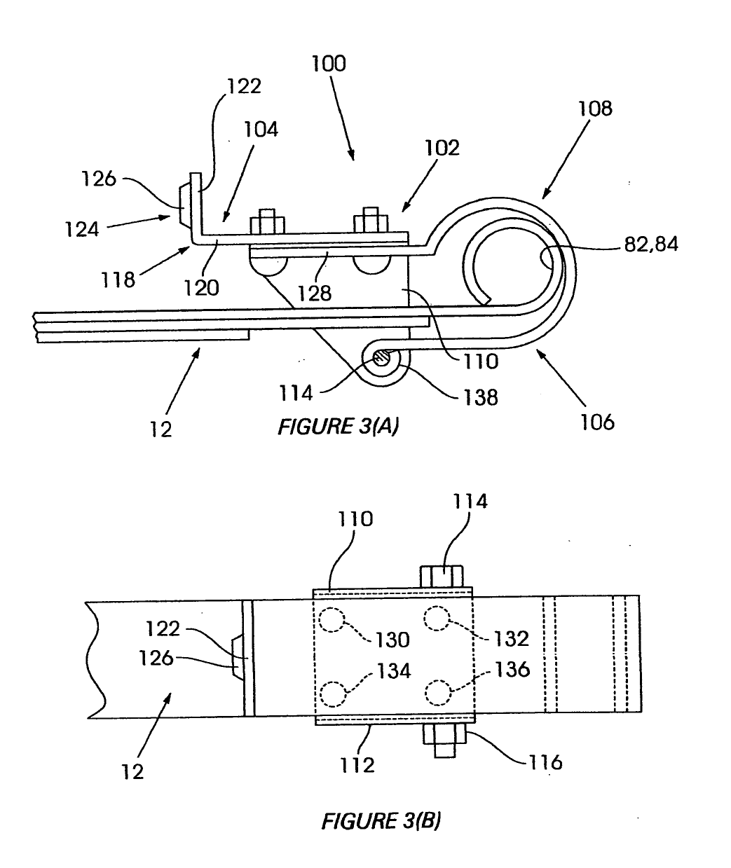

Turning now to FIGS. 3A and 3B, an alternate connector fitting 100 for securing the ends of the first and/or second tension spring arrangements 28, 46, of the supplementary vehicle spring assembly 10 shown in either FIG. 1 or FIG. 2, to a scrolled end 82, 84 of a leaf spring 12 is shown. The connector fitting 100 is used to enclose the scrolled ends 82, 84 of the leaf spring assembly 12. In particular, the connector fitting 100 comprises a bracket arrangement 102 defining a first end 104, the first end 104 being locatable operatively above the leaf spring assembly 12. The connector fitting 100 further defines a second end 106 that is locatable operatively below the leaf spring assembly 12, and an intermediate socket section 108 extending between the first and second ends, 104, 106 for receiving and accommodating the scrolled ends 82, 84 of the leaf spring assembly 12.

A pair of support plates 110, 112 extends on either side of the leaf spring assembly 12 for connecting the first end 104 of the connector fitting 100 to the second end 106 of the connector fitting 100. Each support plate 110, 112 defines varying sized slots for accommodating varying sized leaf spring blade widths.

Typically, each support plate 110, 112 defines an aperture for receiving a retaining bolt 114 and nut 116 for securing the support plates 110 and 112 to each other and for securing together the first and second ends 104, 106 of the connector fitting 106.

Conveniently, the first end 104 of the connector fitting 100 comprises an L-shaped terminating element 118 comprising a base 120 and a tail plate 122 (which functionally is the equivalent of flanged ends 86, 88 of the connector arms 30, 48 in FIGS. 1 and 2). The tail plate 122 defines an aperture 124 into which is fitted a cup bearing 126 (similar to the cup bearings 33 and 50 in FIGS. 1 and 2) that receives the first threaded connector rods 32, 49 extending from the tension springs 36, 52, as described above.

The first end 104 of the connector fitting 100 further comprises a bottom plate 128 extending from the intermediate socket section 108, the L-shaped terminating element 118 and the bottom plate 128 being arranged to overlap each other. Securing means, in the form of a plurality of bolts and nuts 130, 132, 134 and 136 is used to secure the L-shaped terminating element 118 and the bottom plate 128 to each other. Preferably, the second end 106 defines a rolled eye 138 for receiving the securing bolt 114, the rolled eye 138 extending between the pair of support plates 110, 112.

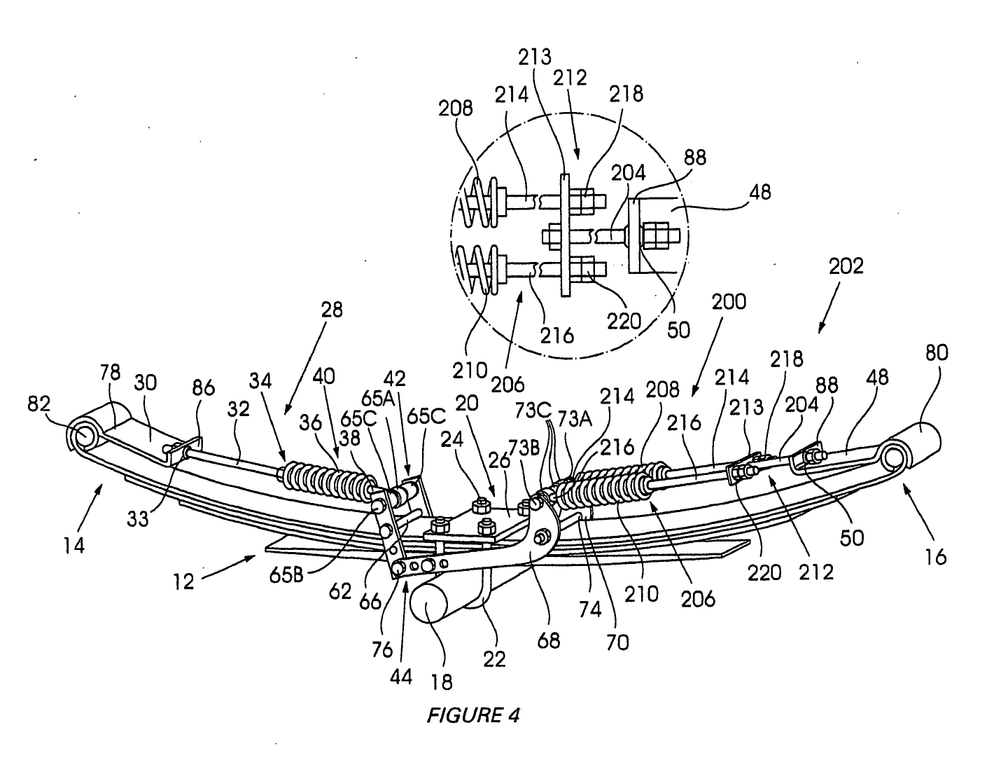

Turning now to FIG. 4, an alternate supplementary vehicle spring assembly 200 for an axle-mounted leaf spring assembly 12 of a vehicle is shown. The spring assembly 200 is substantially similar to the supplementary vehicle spring assembly 10 described above; thus, similar components are labeled identically and their descriptions will not be repeated for the sake of brevity. In essence, the spring assembly 200 comprises the first tension spring arrangement 28 fitted to the fixed end 14 of the leaf spring 12, as described above. The spring assembly 200 further comprises a second tension spring arrangement 202 fitted to the free end 16 of the leaf spring 12. The second tension spring arrangement 202 comprises a connector arm 48 for securing the arrangement 202 to the free end 16 of the leaf spring 12. A first threaded capscrew and bearing connector rod 204 extends from the connector arm 48 and is adjustably securable to a first end 206 of a pair of tension springs 208, 210 via an attachment arrangement 212.

The attachment arrangement 212 comprises an attachment plate 213 that threadably receives the connector rod 204. The attachment plate 213 also receives threaded connector rods 214, 216 extending from the springs 208, 210. The connector rods 214, 216 can thus be adjusted by adjusting the nut sets 218, 220, respectively.

Thus, the essential difference is the pair of tension spring 208, 210, as opposed to the single tension spring 52 shown in FIGS. 1 and 2. A combination of the single spring and the pair of springs can be used to supplement the compressive resistance of leaf springs in a range of vehicle sizes, from 900 metric kilograms right up to 5500 metric kilograms.

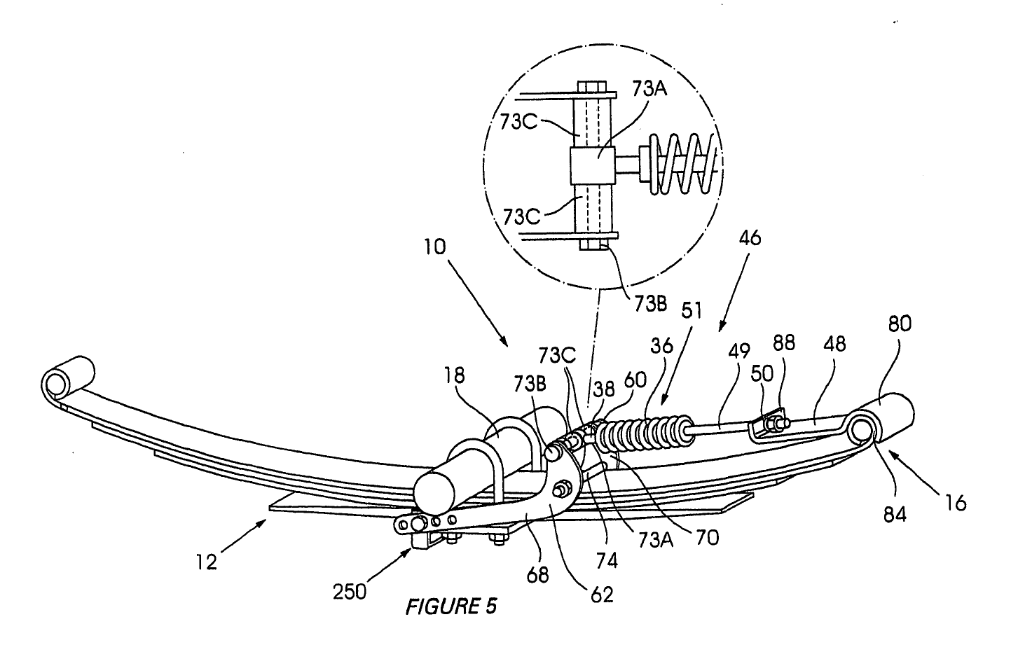

Turning now to FIG. 5, which is substantially similar to FIG. 2 described above, the leaf spring assembly 12 is fitted with only one spring arrangement 46 on its rear, free end 16. The spring arrangement 46 is substantially similar to the spring arrangement 46 described above with particular reference to FIG. 2. Similar components have been numbered similarly, and thus will not be described in more detail, save to mention that the distal ends of the pair of spaced apart L-shaped arms 68, 70 are bolted to an end bracket arrangement 250. Although the arms 68, 70 are shown to extend below the axle 18, in certain applications the arms 68, 70 will extend above the axle 18.

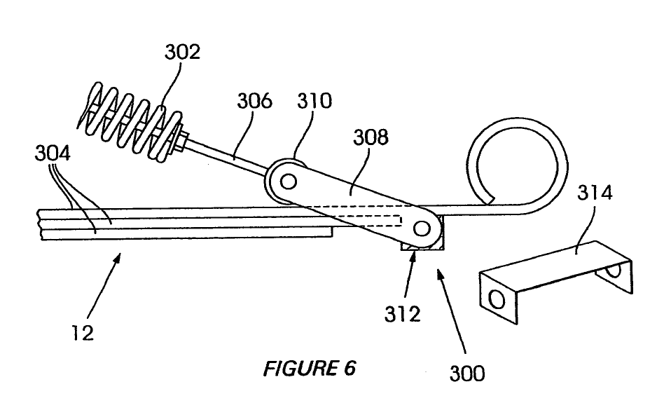

Turning now to FIG. 6, a connecting arrangement 300 for fitting an end of a tension spring 302 to an end of a leaf spring assembly 12 is shown. This arrangement 300 may be used in cases where the curved ends 78, 80 of the connector arms 30, 48, as described above, cannot be used. This arrangement 300 is particularly well suited for heavier commercial vehicles. A connector rod 306 extends from the spring 302, which is then fitted to a pair of spaced apart plates 308 (only one of which is shown) with a roller bearing 310. A solid anchor block 312, made from steel or any other equally strong material, may then be used to anchor the ends of the plates 308 against the blades 304. In addition to, or instead of, the block 312, a securing bracket 314 may be fitted above the blades 304.

The supplementary vehicle spring assemblies described above have the following advantages:
1. They can be used both where the axle is under the leaf spring assembly and where the axle is above the leaf spring assembly. This provides flexibility in terms of manufacture and sales.
2. There is no need to remove any existing component, and so can be easily retrofitted.
3. The pairing of two tension springs enables the spring assembly to react quickly depending upon the terrain that the vehicle is traversing, thereby greatly reducing stresses on the end eyes of the leaf springs.
4. The present invention provides improved rollover as a result of the instantaneous action provided by the tension spring assembly and smooth action proximate the axle connection, handling, loading stability and safety against cross winds.
5. The present invention transforms the passive action of existing leaf spring suspensions into a mechanically active vehicle spring assembly.
6. The vehicle spring assembly of the present invention can be fitted to a far greater range of vehicle sizes, including one tonner vehicles, 4×4 vehicles, SUV's and other vehicles within the medium to heavy commercial markets, large vans, container trailers, trucks, public and passenger bus fleets.
7. The present invention greatly reduces shock on a vehicle's suspension, thus extending the life of leaf springs, shock absorbers and tires.

In addition, some vehicles are fitted with helper springs on top of the leaf spring to assist and prevent bottoming through to the axle. In such cases, these helper springs may be removed by loosening the U-bolts 22, 24, to then enable the supplementary vehicle spring assembly 10 to be fitted in place of the helper springs. A spacer having a required thickness and width may be fitted to replace the thickness of the leaf spring pack. The U-bolts 22, 24 may then be refitted. The supplementary vehicle spring assembly 10 thus makes the use of a helper spring unnecessary. The resultant combination of the active supplementary vehicle spring assembly 10 and passive leaf spring 12 further improves the vehicle's stability and simultaneously ensures no bottoming out of the leaf spring 12.

1. A supplementary vehicle spring assembly for a leaf spring of a vehicle, the leaf spring defining a fixed end and a free end, the supplementary vehicle spring assembly comprising:
a first tension spring arrangement fitted to the fixed end of the leaf spring;
a second tension spring arrangement fitted to the free end of the leaf spring; and
a bracket arrangement proximate an axle of the vehicle, the bracket arrangement connecting the first and second tension spring arrangements.

2. The supplementary vehicle spring assembly of claim 1, wherein the first and second tension spring arrangements each comprise:
a connector arm for securing the arrangements to the respective ends of the leaf spring;
a first connector rod extending from the connector arm and being secured to a first end of at least one tension spring; and
a second connector rod extending from a second end of the tension spring, the second connector rods securing the first and second tension spring arrangements to opposite ends of the bracket arrangement.

3. The supplementary vehicle spring assembly of claim 2, wherein the second tension spring arrangement proximate the free end comprises a pair of springs.

4. The supplementary vehicle spring assembly of claim 3, wherein an adjustment arrangement is provided between the first ends of the pair of springs and the first connector rod.

5. The supplementary vehicle spring assembly of claim 2, wherein the bracket arrangement comprises a first pair of spaced apart arms and a cross-member to which the second connector rod of the first tension spring arrangement is secured, the first pair of spaced apart arms and cross-member defining a moving shackle.

6. The supplementary vehicle spring assembly of claim 5, wherein the second connector rod of the first tension spring arrangement extending from the second end of the tension spring comprises a spherical bearing that in turn is fitted to the cross-member.

7. The supplementary vehicle spring assembly of claim 5, wherein the cross-member is rotatably fitted between the first pair of spaced apart arms, with the second connector rod of the first tension spring arrangement being secured to the rotatable cross-member.

8. The supplementary vehicle spring assembly of claim 5, wherein the bracket arrangement further comprises a second pair of spaced apart arms and a cross-member to which the second connector rod of the second tension spring arrangement is secured.

9. The supplementary vehicle spring assembly of claim 8, wherein the second connector rod extending from the second end of each tension spring of the second tension spring arrangement comprises a spherical bearing that in turn is fitted to the cross-member.

10. The supplementary vehicle spring assembly of claim 8, wherein the cross-member is rotatably fitted between the second pair of spaced apart arms, with the second connector rod of the second tension spring arrangement being secured to the rotatable cross-member.

11. The supplementary vehicle spring assembly of claim 8, wherein the first and second pairs of spaced apart arms, opposite their respective cross-members, are rotatably connected together so as to define the bracket arrangement.

12. The supplementary vehicle spring assembly of claim 11, wherein the cross-members of the first and second pairs of spaced apart arms are located above the leaf spring, with the rotatable connection of the first and second pairs of spaced apart arms being located below the leaf spring.

13. The supplementary vehicle spring assembly of claim 2, wherein the connector arms of the first and second tension spring arrangement terminate in curved ends for accommodating, from above, scrolled ends of the leaf spring.

14. The supplementary vehicle spring assembly of claim 13, wherein the connector arms of the first and/or second tension spring arrangements terminate in a connector fitting that encloses the scrolled ends of the leaf spring.

15. A tension spring arrangement for a leaf spring of a vehicle, the leaf spring defining a fixed end and a free end, the tension spring arrangement comprising:
a connector arm for securing the arrangement to the fixed end of the leaf spring;
a first connector rod extending from the connector arm and being secured to a first end of at least one tension spring;
a second connector rod extending from a second end of the tension spring; and
a bracket arrangement proximate an axle of the vehicle, the second connector rod terminating in a spherical bearing rotatably fitted to the bracket arrangement to define a spherical bearing connection.

16. The tension spring arrangement of claim 15, wherein a pair of springs are provided.

17. The tension spring arrangement of claim 15, wherein the bracket arrangement comprises a pair of spaced apart arms and a cross-member that receives the spherical bearing of the second connector rod.

18. The tension spring arrangement of claim 17, wherein at least one spacer is fitted to the cross-member, the at least one spacer extending on at least one side of the spherical bearing.
